(19) United States
(12) Patent Application Publication
(10) Pub. No.: US 2012/0184252 A1
(43) Pub. Date: Jul. 19, 2012

(54) THERMOGRAPHIC AUGMENTED REALITY DISPLAY IN AN ELECTRONIC DEVICE

(76) Inventor: Alexander Samson Hirsch, Highland Park, IL (US)

(21) Appl. No.: 13/007,763

(22) Filed: Jan. 17, 2011

(51) Int. Cl. H04M 3/42

(52) U.S. Cl. 455/414.1

(57) ABSTRACT

An electronic device is configured to capture thermal information of objects and subjects in real-time utilizing a camera or infrared sensors or utilizing a camera and infrared sensors. The electronic device comprises a display which can depict thermal or temperature information regarding objects or subjects overlaid or layered on image data of objects or subjects. Displayed temperature or thermal information can include numeric information corresponding to discrete or bounded or partially bounded areas of objects or subjects. Thermal information or temperature information can be combined with augmented-reality applications in an electronic device and shared with other electronic devices via one or more networks.

### FIELD OF THE TECHNOLOGY

The present disclosure relates generally to electronic devices. More specifically, enabling implementations relate to electronic devices having radiation sensitive receptors and configured to display discrete temperature information relating to physical objects. The technology provides means and methods whereby a camera assembly in an electronic device may be utilized under certain conditions to collect radiative data from objects or subjects and to present temperature information pertaining to objects or subjects in an augmented reality view. In some implementations of the technology, temperature information or temperature data, or thermal information or thermal data, or thermographic information or thermographic data, can be combined with other augmented reality information, for example time information, or geographic information, or time information and geographic information. Augmented reality information comprises a live direct or indirect view of a physical real-world environment, elements of which are augmented by virtual computer-generated sensory input such as sound or graphics. In some implementations of the technology, thermal information or thermal data can be transmitted to other electronic devices.

### BRIEF DESCRIPTION OF THE DRAWINGS

FIG. 1 illustrates a communication system including an electronic device to which example implementations of the technology can be applied.

FIG. 2 illustrates a block diagram of an electronic device within the technology.

FIG. 3 illustrates an electronic device displaying a temperature data of an object.

FIG. 4 illustrates an electronic device displaying temperature data of an object.

FIG. 5 illustrates an electronic device displaying temperature data of a subject.

FIG. 6. illustrates an electronic device displaying temperature data of a subject.

FIG. 7 illustrates an implementation of a rear view of an electronic device within the technology.

FIG. 8. illustrates an electronic device displaying temperature information of an object.

FIG. 9. illustrates the steps in a method within the technology.

### DETAILED DESCRIPTION

Reference will now be made in detail to implementations of the technology. Each example is provided by way of explanation of the technology only, not as a limitation of the technology. It will be apparent to those skilled in the art that various modifications and variations can be made in the present technology. For instance, features described as part of one implementation of the technology can be used on another implementation to yield a still further implementation. Thus, it is intended that the present technology cover such modifications and variations that come within the scope of the technology.

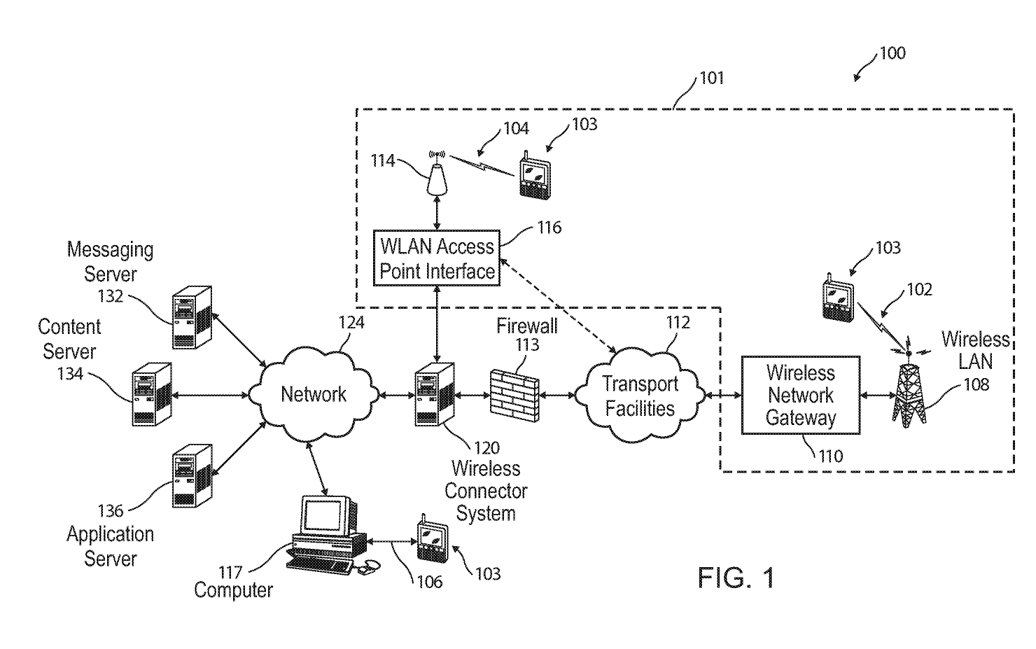

In order to facilitate an understanding of environments in which example implementations described herein can operate, reference is made to FIG. 1, which shows, in block diagram form, a communication system 100 in which implementations of the technology can be applied. The communication system 100 may comprise a number of electronic devices 103 that may be connected to the remainder of system 100 in any of several different ways. Accordingly, several instances of electronic devices 103 are depicted in FIG. 1 employing different example ways of connecting to system 100.

The figures in this application illustrate example of implementations within the technology. Additional elements and modifications may be necessary to make the electronic device, e.g., 103 operable in particular network environments. While in the illustrated implementations, the communication devices, e.g., 103 may comprise smart phones, in other implementations, the electronic devices may comprise personal digital assistants (PDA), tablet computers, laptop computers, desktop computers, servers, or other electronic devices capable of sending and receiving electronic messages.

Electronic devices 103 are connected to a wireless network 101 that may comprise one or more of a Wireless Wide Area Network (WWAN) 102 and a Wireless Local Area Network (WLAN) 104 or other suitable network arrangements. In some implementations, the electronic devices 103 are configured to communicate over both the WWAN 102 and WLAN 104, and to roam between these networks. In some implementations, the wireless network 101 may comprise multiple WWANs 102 and WLANs 104.

The WWAN 102 may be implemented as any suitable wireless access network technology. By way of example, but not limitation, the WWAN 102 may be implemented as a wireless network that includes a number of transceiver base stations 108 where each of the base stations 108 provides wireless Radio Frequency (RF) coverage to a corresponding area or cell. The WWAN 102 is typically operated by a mobile network service provider that provides subscription packages to users of the electronic devices 103. In some implementations, the WWAN 102 conforms to one or more of the following wireless network types: Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network), EvDO (Evolution-Data Optimized) CDMA2000, EDGE (Enhanced Data rates for GSM Evolution), UMTS (Universal Mobile Telecommunication Systems), HSPDA (High-Speed Downlink Packet Access), IEEE 802.16e (also referred to as Worldwide Interoperability for Microwave Access or “WiMAX”), or various other networks. Although WWAN 102 is described as a “Wide-Area” network, that term is intended herein also to incorporate wireless Metropolitan Area Networks (WMAN) and other similar technologies for providing coordinated service wirelessly over an area larger than that covered by typical WLANs.

The WWAN 102 may further comprise a wireless network gateway 110 that connects the electronic devices 103 to transport facilities 112, and through the transport facilities 112 to a wireless connector system 120. Transport facilities may include one or more private networks or lines, the Internet, a virtual private network, or any other suitable network. The wireless connector system 120 may be operated, for example, by an organization or enterprise such as a corporation, university, or governmental department, which allows access to a network 124 such as an internal or enterprise network (e.g., an intranet), and its resources, or the wireless connector system 120 may be operated by a mobile network provider. In some implementations, the network 124 may be realized using the Internet rather than, or in addition to, an internal or enterprise network.

The wireless network gateway 110 provides an interface between the wireless connector system 120 and the WWAN 102, which facilitates communication between the electronic devices 103 and other devices (not shown) connected, directly or indirectly, to the WWAN 102. Accordingly, communications sent via the electronic devices 103 are transported via the WWAN 102 and the wireless network gateway 110 through transport facilities 112 to the wireless connector system 120. Communications sent from the wireless connector system 120 are received by the wireless network gateway 110 and transported via the WWAN 102 to the electronic devices 103.

The WLAN 104 comprises a wireless network that, in some implementations, conforms to IEEE 802.11x standards (sometimes referred to as Wi-Fi TM) such as, for example, the IEEE 802.11a, 802.11b and/or 802.11g standard. Other communication protocols may be used for the WLAN 104 in other implementations such as, for example, IEEE 802.11n, IEEE 802.16e (also referred to as Worldwide Interoperability for Microwave Access or “WiMAX”), or IEEE 802.20 (also referred to as Mobile Wireless Broadband Access). The WLAN 104 includes one or more wireless RF Access Points (AP) 114 (one of which is shown in FIG. 1) that collectively provide a WLAN coverage area.

The WLAN 104 may be a personal network of the user, an enterprise network, or a hotspot offered by an internet service provider (ISP), a mobile network provider, or a property owner in a public or semi-public area, for example. The access points 114 are connected to an access point (AP) interface 116 that may connect to the wireless connector system 120 directly, (for example, if the access point 114 is part of an enterprise WLAN 104 in which the wireless connector system 120 resides), or indirectly, as indicated by the dashed line in FIG. 1, via the transport facilities 112 if the access point 114 is a personal Wi-Fi network or Wi-Fi hotspot (in which case a mechanism for securely connecting to the wireless connector system 120, such as a virtual private network (VPN), may be used). The AP interface 116 provides translation and routing services between the access points 114 and the wireless connector system 120 to facilitate communication, directly or indirectly, with the wireless connector system 120.

The wireless connector system 120 may be implemented as one or more servers, and is typically located behind a firewall 113. The wireless connector system 120 manages communications, including email, Hypertext Transfer Protocol (HTTP), and HTTP Secure (HTTPS) communications to and from a set of managed electronic devices 103. The wireless connector system 120 also provides administrative control and management capabilities over users and electronic devices 103 that might connect to the wireless connector system 120.

The wireless connector system 120 allows the electronic devices 103 to access the network 124 and connected resources and services such as a messaging server 132 (for example, a Microsoft Exchange Server®, IBM Lotus Domino®, or Novell GroupWise™ email server), a content server 134 for providing content such as Internet content or content from an organization's internal servers, application servers 136 for implementing server-based applications such as instant messaging (IM) applications to electronic devices 103, and intranet file services.

The wireless connector system 120 typically provides a secure exchange of data (e.g., email messages, personal information manager (PIM) data, and IM data) with the electronic devices 103. In some implementations, communications between the wireless connector system 120 and the electronic devices 103 are encrypted. In some implementations, communications are encrypted using a symmetric encryption key implemented using Advanced Encryption Standard (AES) or Triple Data Encryption Standard (Triple DES) encryption. Private encryption keys are generated in a secure, two-way authenticated environment and are used for both encryption and decryption of data. In some implementations, the private encryption key is stored only in the user's mailbox on the messaging server 132 and on the electronic device 103, and can typically be regenerated by the user on electronic devices 103. Data sent to the electronic devices 103 is encrypted by the wireless connector system 120 using the private encryption key retrieved from the user's mailbox. The encrypted data, when received on the electronic devices 103, is decrypted using the private encryption key stored in memory. Similarly, data sent to the wireless connector system 120 from the electronic devices 103 is encrypted using the private encryption key stored in the memory of the electronic device 103. The encrypted data, when received on the wireless connector system 120, is decrypted using the private encryption key retrieved from the user's mailbox.

The wireless network gateway 110 is adapted to send data packets received from the electronic device 103 over the WWAN 102 to the wireless connector system 120. The wireless connector system 120 then sends the data packets to the appropriate connection point such as the messaging server 132 or content servers 134 or application server 136. Conversely, the wireless connector system 120 sends data packets received, for example, from the messaging server 132 or content servers 134 or application servers 136 to the wireless network gateway 110 that then transmit the data packets to the destination electronic device 103. The AP interfaces 116 of the WLAN 104 provide similar sending functions between the electronic device 103, the wireless connector system 120 and network connection point such as the messaging server 132, content server 134 and application server 136.

The network 124 may comprise a private local area network, metropolitan area network, wide area network, the public Internet or combinations thereof and may include virtual networks constructed using any of these, alone, or in combination. An electronic device 103 may alternatively connect to the wireless connector system 120 using a computer 117, such as desktop or notebook computer, via the network 124. A link 106 may be provided for exchanging information between the electronic device 103 and a computer 117 connected to the wireless connector system 120. The link 106 may comprise one or both of a physical interface and short-range wireless communication interface. The physical interface may comprise one or combinations of an Ethernet connection, Universal Serial Bus (USB) connection, Firewire™ (also known as an IEEE 1394 interface) connection, or other serial data connection, via respective ports or interfaces of the electronic device 103 and computer 117. The short-range wireless communication interface may be a personal area network (PAN) interface. A Personal Area Network is a wireless point-to-point connection meaning no physical cables are used to connect the two end points. The short-range wireless communication interface may comprise one or a combination of an infrared (IR) connection such as an Infrared Data Association (IrDA) connection, a short-range radio frequency (RF) connection such as one specified by IEEE 802.15.1 or the BLUETOOTH special interest group, or IEEE 802.15.3a, also referred to as UltraWideband (UWB), or other PAN connection.

It will be appreciated that the above-described communication system is provided for the purpose of illustration only, and that the above-described communication system comprises one possible communication network configuration of a multitude of possible configurations for use with the electronic devices 103. Suitable variations of the communication system are intended to fall within the scope of the present disclosure.

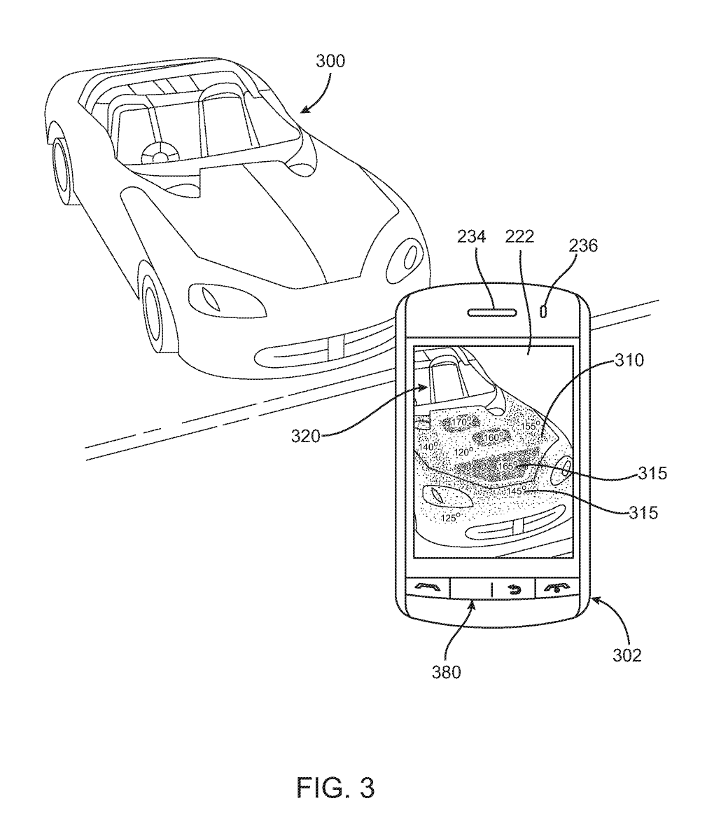

As will be appreciated from FIG. 3, an example electronic device 302 (as an example of 103) comprises a display 222 which can be located above a keyboard 232 (not shown) constituting a user input means that is suitable for accommodating textual input to the device 302. In some implementations, the keyboard 232 can be part of a touch screen display 222. The front face of the device 302 has a navigation row 380. As shown, the device 302 is of uni-body construction, also known as a “candy-bar” design.

The device 302 may include an auxiliary input that acts as a cursor navigation tool and that may be also exteriorly located upon the front face of the device 302. The front face location of a cursor navigation tool allows the tool to be thumb-actuable, e.g., like the keys of the keyboard 232. Some implementations of the technology provide the navigation tool in the form of a trackball (not shown) that may be utilized to instruct two-dimensional screen cursor movement in substantially any direction, as well as act as an actuator when the trackball is depressed like a button. Other implementations can provide the navigation tool in the form of a trackpad, a touchpad, a pointing stick, joystick, graphics tablet, or combinations thereof. The placement of the navigation tool can be above the keyboard 232 and below the display 222; here, it may avoid interference during keyboarding and does not block the operator's view of the display 222 during use.

The device 302 may be configured to send and receive messages. The device 302 includes a body that can, in some implementations, be configured to be held in one hand by an operator of the device 302 during text entry. A display 222 is included that is located on a front face of the body and upon which information is displayed to the operator, e.g., during text entry. As will be described in further detail below, information can include temperature information of objects and subjects. The device 302 may also be configured to send and receive voice communications such as mobile telephone calls. The device 302 also can include a camera 221 to allow the device 302 to take electronic photographs that can be referred to as photos or pictures or image data. A camera can also be utilized to receive thermal information of objects. The device 302 can include an audio recorder that can be incorporated into a microphone or can be separated from a microphone 236. The microphone can be used to receive audio data in conjunction with image or thermographic data collected by one or more sensors relating to an object or a subject. Further, the device 302 can be configured to operate a web browser.

The device 302 may further contain other sensors, e.g., proximity sensor, behind a cover mounted in an aperture defined in body of the electronic device 302. In devices where substantially all the front face of the device is a touch screen, a portion of the touch screen can constitute the cover.

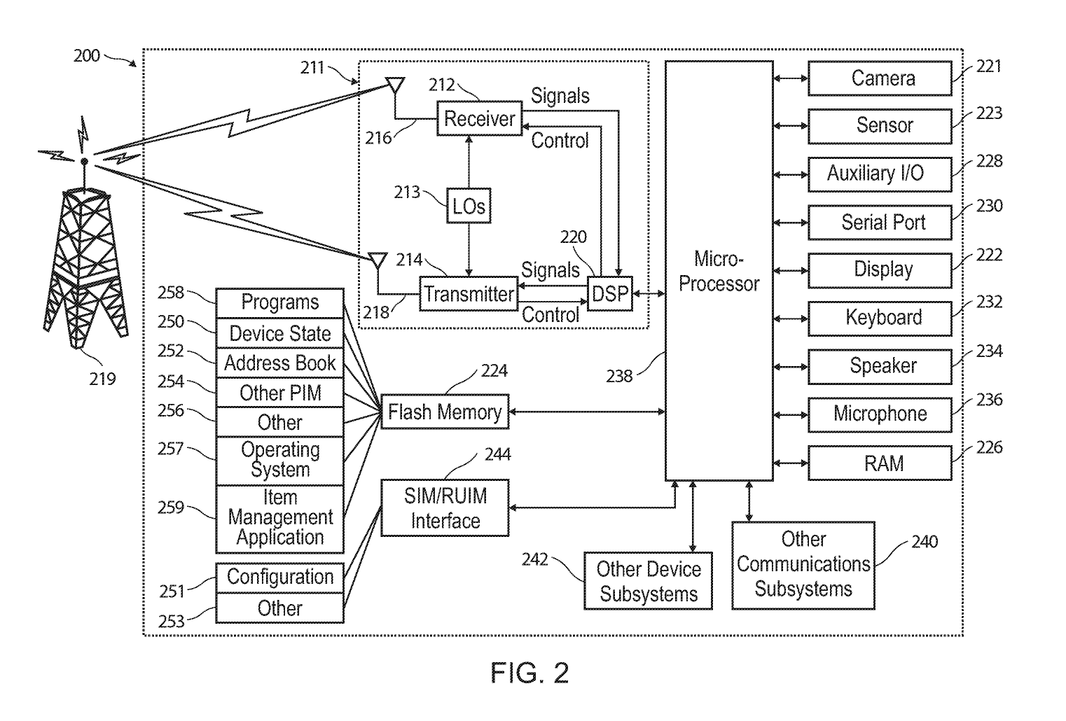

Referring to FIG. 2, a block diagram of a an electronic device, such as 302 and 103, in accordance with an exemplary implementation is illustrated. As shown, the device 302 includes a processor 238 that controls the operation of the electronic device 302. A communication subsystem 211 performs communication transmission and reception with the wireless network 219. The microprocessor 238 further can be communicatively coupled with an auxiliary input/output (I/O) subsystem 228. In at least one implementation, the processor 238 can be communicatively coupled to a serial port (for example, a Universal Serial Bus port) 230 that can allow for communication with other devices or systems via the serial port 230. A display 222 can be communicatively coupled to processor 238 to allow for display of information to an operator of the electronic device 302. When the electronic device 302 is equipped with a keyboard 232, the keyboard can also be communicatively coupled with the processor 238. The electronic device 302 can include a speaker 234, a microphone 236, random access memory (RAM) 226, and flash memory 224, all of which may be communicatively coupled to the processor 238. Other similar components may be provided on the electronic device 302 as well and optionally communicatively coupled to the processor 238. Other communication subsystems 240 and other device subsystems 242 are generally indicated as being functionally connected with the processor 238 as well. An example of a communication subsystem 240 is a short range communication system such as BLUETOOTH® communication module or a WI-FI® communication module (a communication module in compliance with IEEE 802.11b) and associated circuits and components. Examples of other device subsystem 242 include a sensor and implementations of the present technology.

Additionally, the processor 238 is able to perform operating system functions and enables execution of programs on the electronic device 302. In some implementations not all of the above components are included in the electronic device 302. For example, in at least one implementation, the keyboard 232 is not provided as a separate component and is instead integrated with a touch screen as described below.

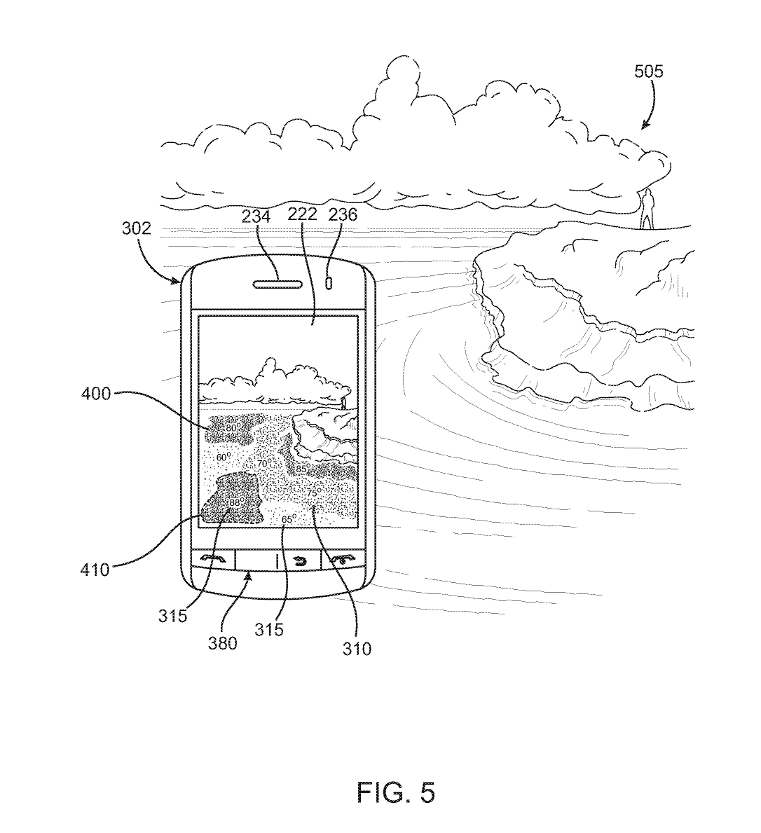

The auxiliary I/O subsystem 228 can take the form of a variety of different navigation tools (mufti-directional or single-directional) such as a trackball navigation tool 521, as illustrated in the exemplary implementation shown in FIG. 5, or a thumbwheel, a navigation pad, a joystick, touch-sensitive interface, or other I/O interface. These navigation tools may be located on the front surface of the electronic device 302 or may be located on any exterior surface of the electronic device 302. Other auxiliary I/O subsystems may include external display devices and externally connected keyboards (not shown). While the above examples have been provided in relation to the auxiliary I/O subsystem 228, other subsystems capable of providing input or receiving output from the electronic device 302 are considered within the scope of this disclosure. Additionally, other keys may be placed along the side of the electronic device 302 to function as escape keys, volume control keys, scrolling keys, power switches, or user programmable keys, and may likewise be programmed accordingly.

The keyboard 232 can include a plurality of keys that can be of a physical nature such as actuable buttons, or the actuable buttons can be of a software nature, typically constituted by representations of physical keys on a display 222 (referred to herein as “virtual keys”). It is also contemplated that the user input can be provided as a combination of the two types of keys. Each key of the plurality of keys is associated with at least one action that can be the input of a character, a command or a function. In this context, “characters” are contemplated to exemplarily include alphabetic letters, language symbols, numbers, punctuation, insignias, icons, pictures, and even a blank space.

In the case of virtual keys, the indicia for the respective keys are shown on the display 222, which in one implementation is enabled by touching the display 222, for example, with a stylus, finger, finger tip, finger nail, or other pointer, to generate the character or activate the indicated command or function. Some examples of displays 222 capable of detecting a touch include resistive, capacitive, projected capacitive, infrared and surface acoustic wave (SAW) touch screens.

Physical and virtual keys can be combined in many different ways as appreciated by those skilled in the art. In one implementation, not shown, physical and virtual keys are combined such that the plurality of enabled keys for a particular program or feature of the electronic device 302 is shown on the display 222 in the same configuration as the physical keys. Using this configuration, the operator can select the appropriate physical key corresponding to what is shown on the display 222. Thus, the desired character, command or function is obtained by depressing the physical key corresponding to the character, command or function displayed at a corresponding position on the display 222, rather than touching the display 222.

Furthermore, the electronic device 302 is equipped with components to enable operation of various programs, as shown in FIG. 2. Programs can be implemented for receiving radiation in the infrared range from an object, determining a thermogram from the received radiation, receiving information regard emissivity of the object, calculating or estimating temperature as a function of received radiation, as a function of the thermogram, and the received information regarding emissivity of the object, and for displaying on the display 222 a numerical representation of the calculated temperature as a layer on a visual depiction of the an object or a subject. In an example implementation, the flash memory 224 is enabled to provide a storage location for the operating system 257, device programs 258, and data. The operating system 257 is generally configured to manage other programs 258 that are also stored in memory 224 and executable on the processor 238. The operating system 257 honors requests for services made by programs 258 through predefined program interfaces. More specifically, the operating system 257 typically determines the order in which multiple programs 258 are executed on the processor 238 and the execution time allotted for each program 258, manages the sharing of memory 224 among multiple programs 258, handles input and output to and from other device subsystems 242, and so on. In addition, operators typically can interact directly with the operating system 257 through a user interface usually including the keyboard 232 and display 222. While in an exemplary implementation the operating system 257 is stored in flash memory 224, the operating system 257 in other implementations is stored in read-only memory (ROM) or similar storage element (not shown). As those skilled in the art will appreciate, the operating system 257, device program 258, or parts thereof, may be loaded in RAM 226 or other volatile memory.

In some implementations, the flash memory 224 may contain programs 258 for execution on the device 302, including—but not limited to—an address book 252, a personal information manager (PIM) 254, and a device state 250. Furthermore, programs 258, such as social software, and other information 256 including data can be segregated upon storage in the flash memory 224 of the device 302.

When the electronic device 302 is enabled for two-way communication within the wireless communication network 219 (e.g., 108), it can send and receive signals from a mobile communication service. Examples of communication systems enabled for two-way communication include, but are not limited to, the General Packet Radio Service (GPRS) network, the Universal Mobile Telecommunication Service (UMTS) network, the Enhanced Data for Global Evolution (EDGE) network, the Code Division Multiple Access (CDMA) network, High-Speed Packet Access (HSPA) networks, Universal Mobile Telecommunication Service Time Division Duplexing (UMTS-T9), Ultra Mobile Broadband (UMB) networks, Worldwide Interoperability for Microwave Access (WiMAX), and other networks that can be used for data and voice, or just data or voice. For the systems listed above, the electronic device 302 may use a unique identifier to enable the electronic device 302 to transmit and receive signals from the communication network 219. Other systems may not use such identifying information. GPRS, UMTS, and EDGE use a Subscriber Identity Module (SIM) in order to allow communication with the communication network 219. Likewise, most CDMA systems use a Removable User Identity Module (RUIM) in order to communicate with the CDMA network. The RUIM and SIM card can be used in multiple different electronic devices 302. An electronic device 302 can be configured to operate some features without a SIM/RUIM card, but an electronic device will not necessarily be able to communicate with the network 219. A SIM/RUIM interface 244 located within the electronic device 302 allows for removal or insertion of a SIM/RUIM card (not shown). The SIM/RUIM card features memory and holds key configurations 251, and other information 253 such as identification and subscriber related information. With a properly enabled electronic device 302, two-way communication between the electronic device 302 and communication network 219 is possible.

If the electronic device 302 is enabled as described above or the communication network 219 does not use such enablement, the two-way communication enabled electronic device 302 is able to both transmit and receive information from the communication network 219. The transfer of communication can be from the electronic device 302 or to the electronic device 302. In order to communicate with the communication network 219, the device 302 can be equipped with an integral or internal antenna 218 for transmitting signals to the communication network 219. Likewise the device 302 can be equipped with another antenna 216 for receiving communication from the communication network 219. These antennae (216, 218) in another exemplary implementation are combined into a single antenna (not shown). As one skilled in the art would appreciate, the antenna or antennae (216, 218) in another implementation can be externally mounted on the electronic device 302.

When equipped for two-way communication, the electronic device 302 features a communication subsystem 211. As is understood in the art, a communication subsystem 211 is modified so that a communication subsystem can support the operational needs of an electronic device 302. The subsystem 211 includes a transmitter 214 and receiver 212 including the associated antenna or antennae (216, 218) as described above, local oscillators (LOs) 213, and a processing module that in the presently described exemplary implementation is a digital signal processor (DSP) 220.

It is contemplated that communication by the electronic device 302 with the wireless network 219 can be any type of communication that both the wireless network 219 and electronic device 302 are enabled to transmit, receive and process. In general, these can be classified as voice or data, or both voice and data. Voice communication generally refers to communication in which signals for audible sounds are transmitted by the electronic device 302 through the communication network 219. Data generally refers to all other types of communication that the electronic device 302 is capable of performing within the constraints of the wireless network 219.

Example device programs that can depend on such data include email, contacts and calendars. For each such program, synchronization with home-based versions of the program can be desirable for either or both of their long term and short term utility. As an example, emails are often time-sensitive, so substantially real time (or near-real time) synchronization may be desired. Contacts, on the other hand, can be usually updated less frequently without inconvenience. Therefore, the utility of the electronic device 302 is enhanced when connectable within a communication system, and when connectable on a wireless basis in a network 219 in which voice, text messaging, and other data transfer are accommodated. An example real time system wherein operations occur in real time is disclosed in U.S. Pat. No. 5,125,091. U.S. Patent No. is fully incorporated by reference herein. An electronic device 302 can include programs such as a web browser, a file browser, and client programs for interacting with server programs. Devices, e.g., 103, 302, for use in the technology can be characterized by an identification number assigned to the device. Such identification numbers cannot be changed and are locked to each device.

Implementations of the technology receive and display information pertaining to infrared light. Infrared (IR) light is electromagnetic radiation with a wavelength between 0.7 and 300 micrometres, with a corresponding frequency range between approximately 1 and 430 THz (terahertz). IR wavelengths are longer than those of visible light, but shorter are shorter than those of terahertz radiation microwaves. Light from the sun provides an irradiance of over 1 kilowatt per square meter at sea level. Of this energy, 527 watts is infrared radiation, 445 watts is visible light, and 32 watts is ultraviolet radiation.

People at normal body temperature radiate chiefly at wavelengths near 12 μm (micrometers). Objects generally emit infrared radiation across a spectrum of wavelengths, but only a specific region of the spectrum is of interest because sensors 223 can be designed only to collect radiation within a specific bandwidth. As a result, the infrared band can be subdivided into smaller sections. Near-infrared (“NIR”) light has a wavelength of 0.7 to 1.0 μm. Some image intensifiers are sensitive to this area of the light spectrum. Examples can include night vision devices such as night vision goggles.

Short-wavelength infrared light (“SWIR”) has a wavelength of 1.0 to 3 μm.

Mid-wavelength infrared light (“MWIR”), also known as intermediate infrared, has a wavelength of 3 to 5 μm.

Long-wavelength infrared light (“LWIR”) 8 to 12 μm. This is the “thermal imaging” region, in which sensors 223 can obtain a completely passive picture of the outside world, including objects and subjects, based on thermal emissions only and requiring no external light or thermal source such as the sun, moon, infrared illuminator or flash 700.

Very-long wave infrared (“VLWIR”) has a wavelength of 12 to 30 μm. Near infrared is the region closest in wavelength to the radiation detectable by the human eye, mid and far infrared are progressively further from the visible spectrum. The onset of infrared is defined (according to different standards) at various values typically between 700 nm and 800 nm.

Emissivity is relevant to the infrared emissions of objects. Emmisivity is a property of a surface which describes how its thermal emissions deviate from the ideal of a black body. Thus, two objects at the same physical temperature will not appear to have the same temperature in an infrared image if they have differing emmissivities. Thus, in order to obtain an accurate thermogram within the technology, emissivity of an object or subject is received by one or more sensors 223 comprised by an electronic device 302. Within the technology, it can be beneficial to maintain a datastore in one or memories (e.g. 224) relating each of a plurality of material descriptions of objects 300 or subjects to the emissivity of the described material. Within the technology, a device can be configured to present a list of the material descriptions, receive input selecting a material description and assign the emissivity related to the material description as the emissivity of the object 300.

In order to operate as a noncontact temperature receptor, the camera 221 can change the value assigned to temperature of the object 300 being viewed with its emissivity setting. Other algorithms can be used to affect measurements, including the transmission ability of the transmitting medium (usually air) and the temperature of that transmitting medium. All these settings will affect the ultimate output for the temperature of the object being viewed. This functionality makes implementations of the thermal imaging camera 221 useful. Within some implementations of the technology, one or more averaging functions or algorithms are utilized in order to calculate temperatures of objects or subjects. Example averaging functions within the technology can be found in U.S. Pat. No. 6,571,089 (see e.g., Col. 16, lines 60-62, and Col. 18, lines 10-31) and U.S. Pat. No. 7,079,827 (see e.g., Col. 17, line 1-6). U.S. Pat. No. 6,571,089 and U.S. Pat. No. 7,079,827 are fully incorporated by reference herein. Temperature information can be displayed within bounded areas with numeric temperature indicators on a display 222. It can be advantageous to display temperature information overlaid on top of standard image data relating to an object 300.

Returning to the implementation shown in FIG. 3, temperature information is shown on a display 222 on an electronic device 302 as a layer 310 of an image 320 of an object 300. The term layer comprises ‘overlay.’ Various temperatures of the object 300 are represented as Arabic numbers 315. Note that the object 300 image data is not distorted, but rather is augmented with a temperature information or thermographic information.

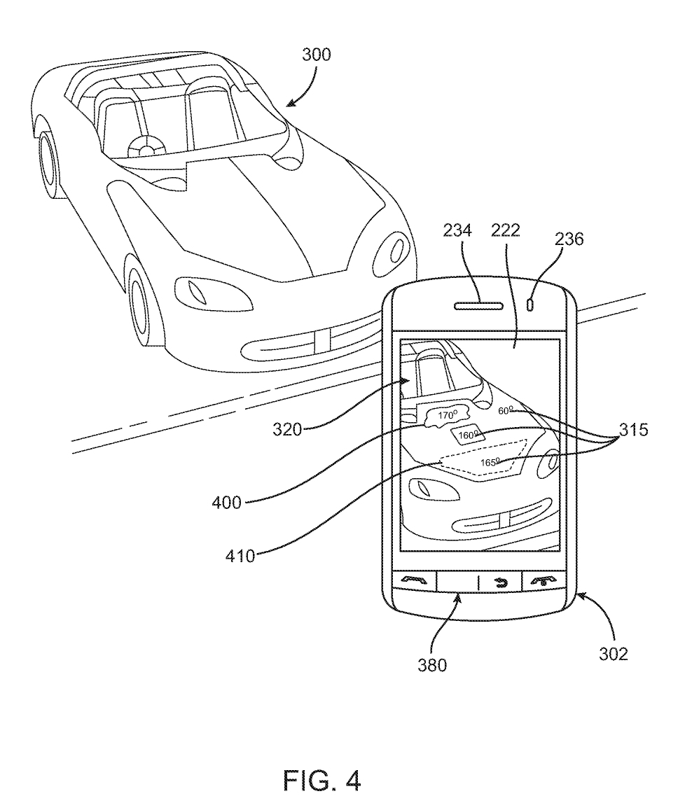

FIG. 4 illustrates an alternate style of depicting temperature information of an object 300 on a display 222. The thermographic information or temperature information corresponding to the camera's object 320 is depicted within bounded temperature areas 400 and partially bounded temperature areas 410. As was the case in FIG. 3, the object 300 image data is not distorted, but rather is augmented with temperature information.

FIG. 5 illustrates temperature information on a display 222 on an electronic device as a layer 310 of an image 320 of a camera subject 505. Various temperatures of the object 300 are represented as Arabic numbers 315.

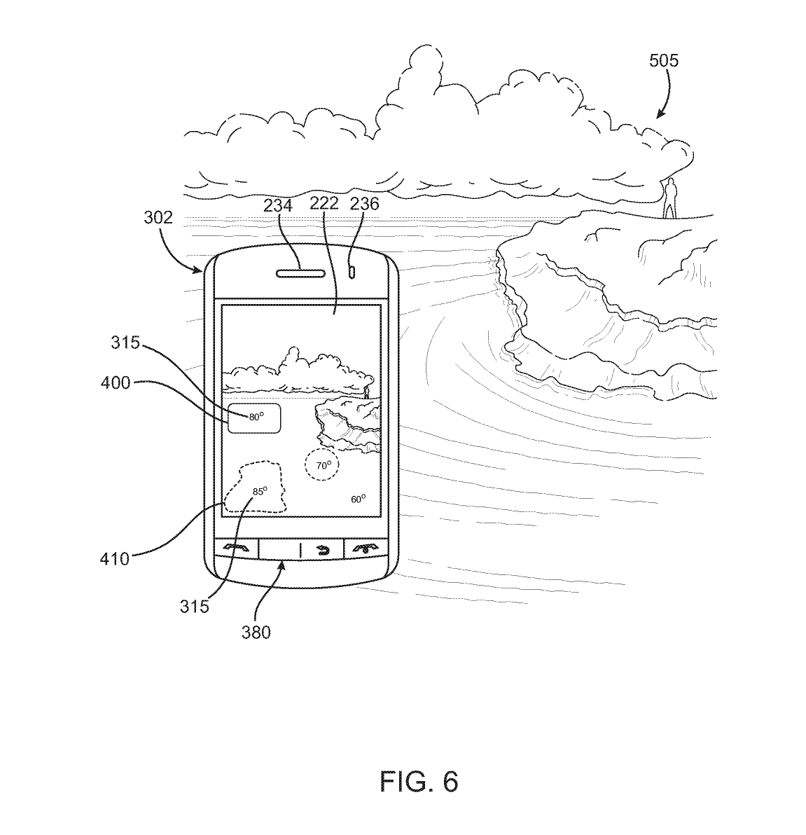

FIG. 6 illustrates an alternative display of temperature information relating to the same subject 505 as in FIG. 5, shown on a display 222 on an electronic device as a layer 310 on an image 320 of the subject 505. Again, temperatures of the subject 505 can be indicated using Arabic numbers 315.

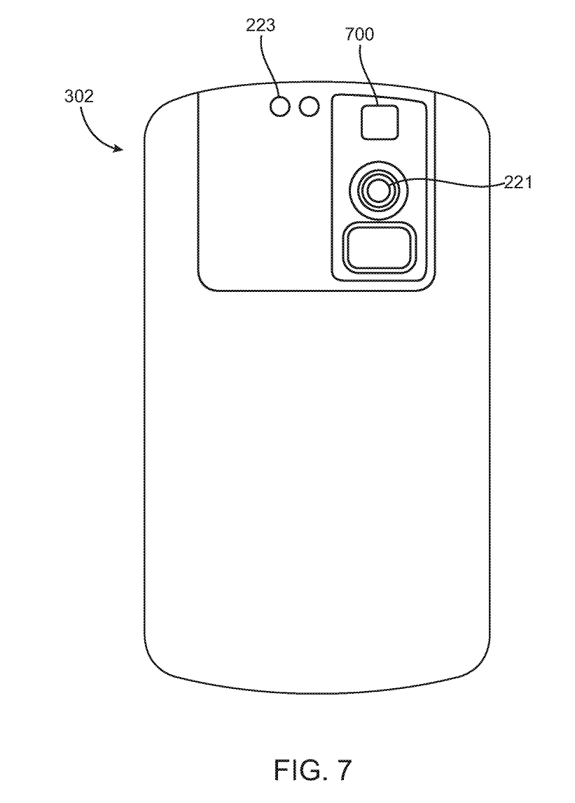

FIG. 7 illustrates a rear view of an electronic device 302 within the technology. In the implementation shown in FIG. 7, a camera 221 and one or more sensors 223 or detectors are shown housed within the device 302.

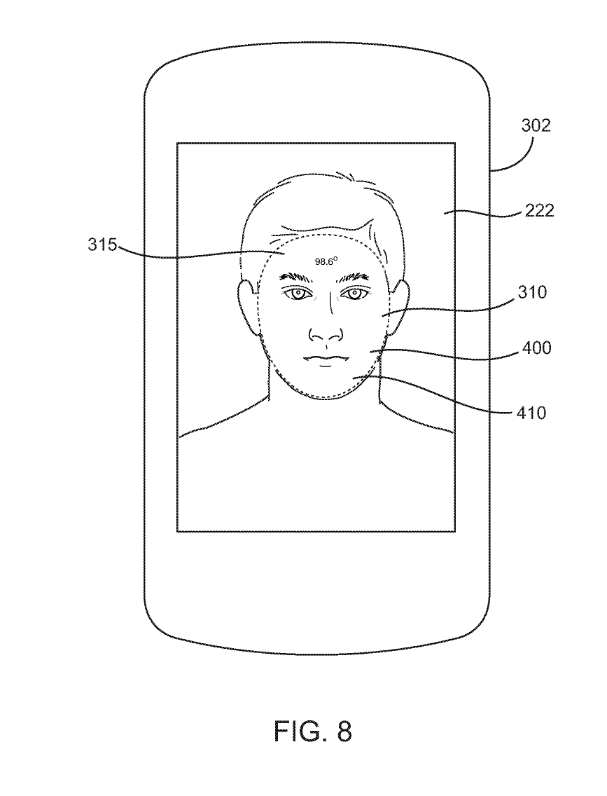

FIG. 8 illustrates a temperature information on a display 222 of a mobile communication device 302 wherein the object 300 is a person. The calculated temperature of the face area of the object 300 is depicted within a bounded area 400. The boundary surrounding the face area is rendered in a broken line, thus the face area is a partially bounded area 410. The calculated average temperature of the face area is depicted as a single number 315. The calculated temperature corresponding to the object 300 can be calculated utilizing an averaging function.

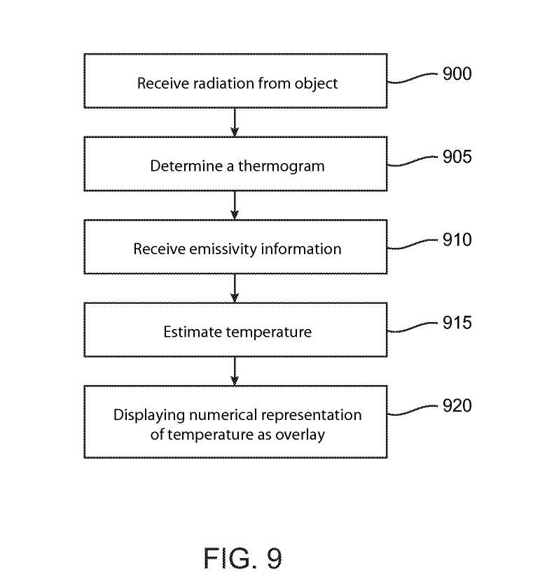

FIG. 9 illustrates the steps in a method for thermography in an electronic device. At 900, Radiation in the infrared range is received from an object 900. At 905, a thermogram is determined from the received radiation. Information regarding emissivity of the object 300 is received 910. At 915, temperature is calculated as a function of received radiation, as a function of the thermogram, and as a function of the received information regarding emissivity of the object 300. A numerical representation of the calculated temperature is displayed 920 as an overlay or layer on a visual depiction of the object 300.

Implementations of the technology can be realized as including programming on an electronic device, e.g., 103. In some implementations, programming for the technology is on the electronic device 103, while data used by the electronic device 103 is on the wireless connector system 120 or a network server such as content server 134, messaging server 132, or application server 136. In some implementations, programming for the technology can be realized on a remote server. Allocation of functionality among architectural elements can be a function of several factors including latency, processing resource availability and efficient usage, storage availability and efficient usage, and revenue opportunities.

Portions of the technology can take the forms of hardware, or both hardware and software elements. In some implementations, the technology is implemented in software, which includes but is not limited to firmware, resident software, microcode, a Field Programmable Gate Array (FPGA) or Application-Specific Integrated Circuit (ASIC), etc. In particular, for real-time or near real-time use, an FPGA or ASIC implementation is desirable.

Furthermore, the present technology can take the form of a computer program product comprising program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device 302. The medium can be an electronic, magnetic, optical, electromagnetic, infrared, or semiconductor system (or apparatus or device 302) or a propagation medium (though propagation mediums as signal carriers per se are not included in the definition of physical computer-readable medium). Examples of a physical computer-readable medium include a semiconductor or solid state memory, removable memory connected via USB, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W), DVD, and Blu Ray™. Both processors and program code for implementing each as aspect of the technology can be centralized or distributed (or a combination thereof).

Furthermore, the present technology can take the form of a computer program product comprising program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device 302. The medium can be an electronic, magnetic, optical, electromagnetic, infrared, or semiconductor system (or apparatus or device 302) or a propagation medium (though propagation mediums as signal carriers per se are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. Both processors and program code for implementing each as aspect of the technology can be centralized or distributed (or a combination thereof).

A data processing system suitable for storing a computer program product of the present technology and for executing the program code of the computer program product will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters can also be coupled to the system to enable the data processing system to become coupled to other data processing systems or remote printers or storage devices through intervening private or public networks. Modems, cable modem, WiFi, and Ethernet cards are just a few of the currently available types of network adapters. Such systems can be centralized or distributed, e.g., in peer-to-peer and client/server configurations. In some implementations, the data processing system is implemented using one or both of FPGAs and ASICs.

1. A method for displaying temperature on a device, the method comprising:
receiving visual information from an object;
capturing radiation in the infrared range based on the object;
calculating temperature based on the captured radiation, and
displaying a numerical representation of the calculated temperature on a visual depiction of the object.

2. The method of claim 1, further comprising determining a thermogram based on the captured radiation and receiving information regarding emissivity of the object; and
wherein calculating temperature is accomplished utilizing an averaging function based the captured radiation, the thermogram, and the received information regarding emissivity of the object.

3. The method of claim 1, wherein displaying a numerical representation of the calculated temperature occurs in real time.

4. The method of claim 1, wherein displaying a numerical representation of the calculated temperature on a visual depiction of the object further comprises:
displaying areas which are at least partially bounded and which are differentiated by color.

5. The method of claim 4, wherein the areas which are differentiated by color correspond to numbers.

6. The method of claim 1, wherein capturing radiation in the infrared range from the object comprises:
receiving radiation in the form of a near infrared range, a short-wave infrared range, and a mid-wave infrared range.

7. The method of claim 1, wherein capturing radiation in the infrared range based on the object comprises:
maintaining a datastore relating each of a plurality of material descriptions to the emissivity of the described material;
presenting a list of the material descriptions;
receiving input selecting a material description; and
assigning the emissivity related to the material description as the emissivity of the object.

8. A computer program product for displaying temperature on a device, the computer program product comprising:
at least one computer readable media, capable of storing and receiving instructions;
instructions stored on the media, that when executed by a processor are operative to:
receive radiation in the infrared range from an object;
determine a thermogram from the received radiation;
receive information regard emissivity of the object;
calculate temperature as a function of received radiation, as a function of the thermogram, and as a function of the received information regarding emissivity of the object, utilizing an averaging function, and
cause to be displayed a numerical representation of the calculated temperature as a layer on a visual display of the object.

9. The computer program product of claim 8, wherein radiation in the infrared range from an object comprises radiation in one of: a near infrared range, a short-wave infrared range, and a mid-wave infrared range.

10. The computer program product of claim 8, wherein radiation in the infrared range from an object comprises radiation in one of: a long-wave infrared range, and a very-long mid-wave infrared range.

11. The computer program product of claim 8, wherein display of the numerical representation of the calculated temperature as a layer on a visual display of the object occurs in real time.

12. The computer program product of claim 8, wherein instructions on the media, that when executed by a processor, are further operative to:
cause to be displayed a real-time numerical representation of the calculated temperature as at least one layer comprising at least one partially bounded area on a visual display of the object.

13. The computer program product of claim 8, wherein instructions on the media, that when executed by a processor, are further operative to:
display at least one real-time numerical representation of the calculated temperature as a layer comprising at least one fully bounded area on a visual display of the object.

14. The computer program produce of claim 8, wherein instructions on the media, that when executed by a processor, are further operative to:
display at least one real-time numerical representation of the calculated temperature as a layer comprising at least one fully bounded area corresponding to a color on a visual display of the object.

15. The computer program product of claim 8, wherein the media maintains a datastore relating each of a plurality of material descriptions to the emissivity of the described material and wherein the instructions on the media, when executed by a processor are further operative to:
present a list of the material descriptions;
receive input selecting a material description; and
assign the emissivity related to the material description as the emissivity of the object.

16. An electronic device, the device comprising:
a display;
processor resources;
at least one computer readable media, capable of receiving and storing information, in communication with the processor resources;
instructions on the media, that when executed by the processor resources are operative to:
receive radiation in the infrared range from an object;
determine a thermogram from the received radiation;
receive information regard emissivity of the object;
estimate temperature as a function of received radiation, as a function of the thermogram, and as a function of the received information regarding emissivity of the object, utilizing an averaging function, and
display a numerical representation of the calculated temperature as a layer on a visual display of the object.

17. The electronic device of claim 16, wherein the radiation comprises one of near infrared radiation, short-wave infrared radiation and mid-wave infrared radiation.

18. The electronic device of claim 16, wherein the radiation comprises one of long-wave infrared radiation and very long-wave infrared radiation.

19. The electronic device of claim 16, wherein the instructions on the media, that when executed by the processor resources, are further operative to:
cause to be displayed a real-time numerical representation of the calculated temperature as a layer on a visual display of the object comprising at least one bounded area.

20. The electronic device of claim 16, wherein the instructions on the media, that when executed by the processor resources, are further operative to:
cause to be displayed a real-time numerical representation of the calculated temperature as a layer on a visual display of the object comprising at least one bounded area which is differentiated by color.
